(19) United States
(12) Patent Application Publication
(10) Pub. No.: US 2026/0348514 A1
(43) Pub. Date: Nov. 5, 2026

(54) SYSTEM FOR INSTALLING OVERHEAD SUPPORT STRUCTURES

(71) Applicant: Allfasteners USA, LLC, Medina, OH (US)

(72) Inventors: Bruce A. Carmichael, Hinckley, OH (US); Michael Strange, Columbia Station, OH (US); Anthony Carmichael, Strongsville, OH (US)

(73) Assignee: Allfasteners USA, LLC, Medina, OH (US)

(21) Appl. No.: 19/664,201

(22) Filed: Apr. 30, 2026

Related U.S. Application Data
(60) Provisional application No. 63/798,518, filed on May 1, 2025.

(51) Int. Cl. F16M 13/02; F16L 3/02

(52) U.S. Cl. CPC F16M 13/02; F16L 3/02

(57) ABSTRACT

An overhead support structure system having an elongated support member and a clamping system for securing the elongated support member to an existing structural member of a facility. The elongated support member includes slots in its top and bottom surfaces. The clamping system includes a top clamp member and a bottom clamp member. During installation, an and of the elongated support member is positioned above a surface of the existing structural member of the facility and between the top clamp member and the bottom clamp member such that a fastener is configured to be passed through the top clamp member, aligned slots of the elongated support member, and the bottom clamp member to clamp the elongated support member to the existing structural member of the facility.

### CROSS REFERENCE TO RELATED APPLICATION

This application claims priority as a non-provisional to co-pending U.S. Provisional Application Ser. No. 63/798,518 filed May 1, 2025, entitled “System for Installing Overhead Support Structures,” the entire contents of which are incorporated herein by reference.

### FIELD

The present disclosure is directed to the field of structural support systems for MEP applications. More specifically, the present disclosure is directed to an overhead support structure system for effectively and efficiently suspending support members at a facility by clamping opposing ends of the support members to existing structural members of the facility.

### BACKGROUND

In many overhead mechanical, electrical and plumbing (“MEP”) applications, it is desired to install various equipment using overhead support structures. Often, the installations take place in challenging environments such as airports, data centers, hospitals, and waste/water treatment plants. Challenges include lifting heavy equipment, difficult assembly, and on-site welding being required to construct the necessary overhead support structures for the equipment installations needed for a particular project.

What is needed therefore is a system for quickly and efficiently installing overhead support structures for MEP applications. More specifically, an overhead support structure system is desired that can utilize existing overhead structural members of a facility to form a desired overhead support structure pattern at the facility.

### SUMMARY

The above and other needs are met by an overhead support structure system comprising an elongated support member and a clamping system for clamping the elongated support member to a structural member of a facility. The elongated support member includes a first end having a hollow interior, a first aperture extending through a top surface of the elongated support member, and a second aperture extending through a bottom surface of the elongated support member. The first aperture and the second aperture of the elongated support member are positioned and configured to be vertically aligned with the hollow interior disposed between the first aperture and the second aperture. The clamping system includes a top clamp member and a bottom clamp member. The top claim member includes at least a first aperture, a second aperture, and a third aperture. The bottom clamp member includes at least a first aperture, a second aperture, and a third aperture with the bottom clamp member being dimensioned and configured such that a rear portion of the bottom clamp member being operable to be positioned underneath a portion of the first structural member while a front portion of the bottom clamp member is operable to be positioned underneath the bottom surface of the first end of the elongated support member. During installation with the top clamp member being positioned above the bottom clamp member with the first end of the elongated support member positioned between the top clamp member and the bottom clamp member, the first aperture of the top clamp member is aligned with the first aperture of the bottom clamp member adjacent a first side of the elongated support member, the second aperture of the top clamp member is aligned with the second aperture of the bottom clamp member adjacent a second side of the elongated support member, and the third aperture of the top clamp member is aligned with the third aperture of the bottom clamp member and the first and second aperture of the elongated support member. Each of the aligned apertures are dimensioned and configured to receive a fastener for securing the first end of the elongated support member to the structural member of the facility by securing the top clamp member to the bottom clamp member with the elongated support member secured between the top clamp member and the bottom clamp member.

According to certain embodiments, the elongated support member includes a hollow interior throughout a length of the elongated support member, a first set of spaced-apart apertures extending along the top surface of the elongated support member that includes the first aperture of the elongated support member, and a second set of spaced-apart apertures extending along the bottom surface of the elongated support member that includes the second aperture of the elongated support member. Each of the apertures of the first-set of spaced-apart apertures are vertically aligned with a corresponding aperture of the second-set of spaced-apart apertures.

According to certain embodiments, the top clamp member includes a first plate having the first aperture and the second aperture of the top clamp member and a second plate having the third aperture of the top clamp member. According to some embodiments, the bottom clamp member is in the form of a unitary plate having the first aperture, second aperture, and third aperture of the bottom clamp member.

According to certain embodiments, one or more of the first aperture, second aperture, and third aperture of the bottom clamp member includes an elongated slot.

According to certain embodiments, the front portion of the bottom clamp member includes a raised portion having a top end that is dimensioned and configured to be positioned closely below the bottom surface of the elongated support member following installation.

According to certain embodiments, the structural member of the facility is an I-beam having a flange and wherein, during installation, the rear portion of the bottom clamp member is dimensioned and configured to be positioned underneath the flange of the I-beam.

According to certain embodiments, the clamping system further includes a washer dimensioned and configured to be positioned between the bottom surface of the elongated support member and the front portion of the bottom clamp member during installation.

According to certain embodiments, at least one of the third aperture of the top clamp member and the third aperture of the bottom clamp member is in the form of an elongated slot for permitting variations in the positioning of the corresponding fastener with respect to the first and second aperture of the elongated support member.

According to another embodiment of the disclosure, a method of securing an overhead support structure system to an existing structural member of a facility includes: providing an elongated support member having a first end, the first end of the elongated support member including a hollow interior, a first aperture extending through a top surface of the elongated support member, and a second aperture extending through a bottom surface of the elongated support member, the first aperture and the second aperture of the elongated support member being positioned and configured to be vertically aligned with the hollow interior disposed between the first aperture and the second aperture; providing a top clamp member having a first aperture, a second aperture, and a third aperture; providing a bottom clamp member having a first aperture, a second aperture, and a third aperture; positioning the first end of the elongated support member on top of a portion of the existing structural member of the facility; positioning the bottom clamp member such that a rear portion of the bottom clamp member is disposed underneath the portion of the existing structural member of the facility and a front portion of the bottom clamp member is disposed underneath the bottom surface of the first end of the elongated support member; positioning the top clamp member above the first end of the elongated support member such that the first aperture of the top clamp member is aligned with the first aperture of the bottom clamp member adjacent a first side of the elongated support member, the second aperture of the top clamp member is aligned with the second aperture of the bottom clamp member adjacent a second side of the elongated support member, and the third aperture of the top clamp member is aligned with the third aperture of the bottom clamp member and the first and second aperture of the elongated support member; and securing the first end of the elongated support member to the existing structural member of the facility by passing fasteners through each of the aligned apertures to securing the top clamp member to the bottom clamp member with the elongated support member secured between the top clamp member and the bottom clamp member.

According to certain embodiments, the elongated support member includes a hollow interior throughout a length of the elongated support member, a first set of spaced-apart apertures extending along the top surface of the elongated support member, and a second set of spaced-apart apertures extending along the bottom surface of the elongated support member, each of the apertures of the first-set of spaced-apart apertures being vertically aligned with a corresponding aperture of the second-set of spaced-apart apertures.

According to certain embodiments, the top clamp member includes a first plate having the first aperture and the second aperture of the top clamp member and a second plate having the third aperture of the top clamp member. In some embodiments, the bottom clamp member is in the form of a unitary plate having the first aperture, second aperture, and third aperture of the bottom clamp member.

According to certain embodiments, or more of the first aperture, second aperture, and third aperture of the bottom clamp member includes an elongated slot.

According to certain embodiments, the front portion of the bottom clamp member includes a raised portion having a top end that is dimensioned and configured to be positioned closely below the bottom surface of the elongated support member during the positioning step of the bottom clamp member.

According to certain embodiments, the existing structural member of the facility is an I-beam having a flange and wherein, during the positioning step of the bottom clamp member, the rear portion of the bottom clamp member is positioned underneath the flange of the I-beam.

According to certain embodiments, the method further includes positioning a washer between the bottom surface of the elongated support member and the front portion of the bottom clamp member.

According to certain embodiments, at least one of the third aperture of the top clamp member and the third aperture of the bottom clamp member is in the form of an elongated slot for permitting variations in the positioning of the corresponding fastener with respect to the first and second aperture of the elongated support member.

### BRIEF DESCRIPTION OF THE DRAWINGS

Other embodiments of the disclosure will become apparent by reference to the detailed description in conjunction with the figures, wherein elements are not necessarily to scale so as to more clearly show the details, and wherein like reference numbers indicate like elements throughout the several views, and wherein:

FIG. 1 depicts a perspective view of a clamping system for clamping one end of a support member to an existing I-beam of a facility according to one embodiment of the disclosure.

FIG. 2 depicts an overhead perspective view of a support member according to one embodiment of the disclosure.

FIG. 3 depicts a close-up perspective end view of the support member of FIG. 2.

FIG. 4 depicts an overhead perspective view of a bottom clamp member of the clamping system according to one embodiment of the disclosure.

FIG. 5 depicts an overhead support structure system having a support member secured at opposing ends to existing I-beams of a facility using the clamping system according to one embodiment of the disclosure.

FIG. 6 depicts an overhead support structure in which multiple support members are secured in a desired pattern to existing I-beams of a facility according to one embodiment of the disclosure.

FIG. 7 depicts a perspective view of a clamping system for clamping one end of a support member to an existing I-beam of a facility according to another embodiment of the disclosure.

### DETAILED DESCRIPTION

The following description of preferred embodiments for this disclosure is presented for purposes of illustration and description. It is not intended to be exhaustive or to limit the disclosure to the precise form disclosed. Obvious modifications or variations are possible in light of the following teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure.

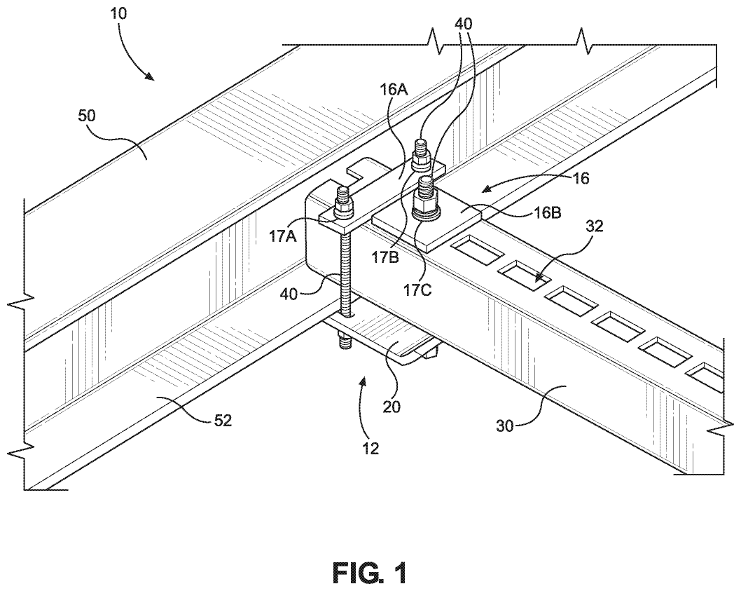

With reference to FIG. 1, an overhead support structure system 10 for MEP applications is provided according to one exemplary embodiment of the disclosure. In particular, the system 10 is optimally designed for supporting HVAC ductwork, piping, and other mechanical equipment using a clamping system 12 designed to securely attach the overhead support structure system 10 to existing structural members of a facility. As shown and described herein, the clamping system 12 of the present disclosure is specifically designed to be compatible with existing I-beams already installed at a facility. However, it should be understood that the system 10 may be secured to other existing structural members that include a suitable surface for utilizing the camping system 12 in a similar manner as described herein with respect to the I-beams.

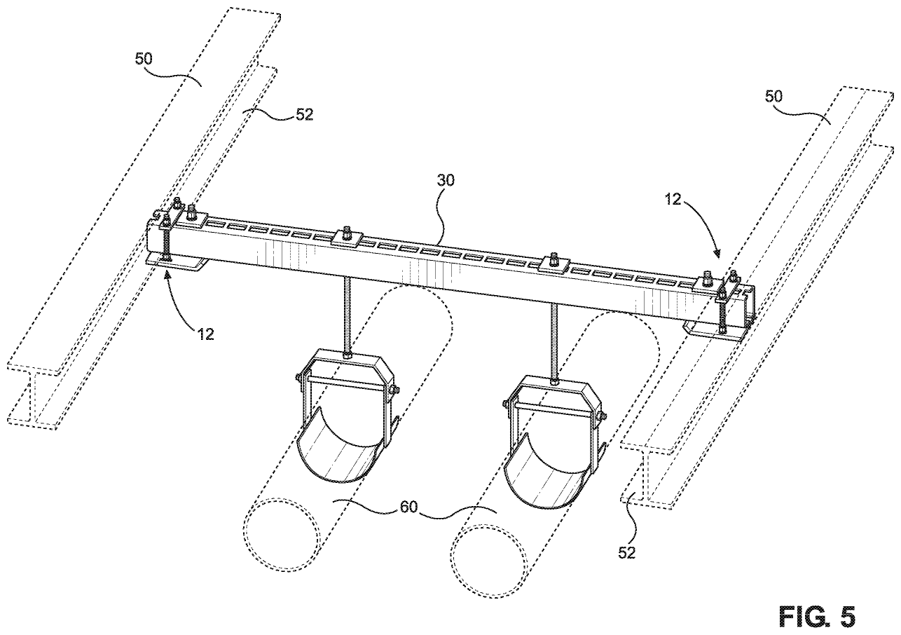

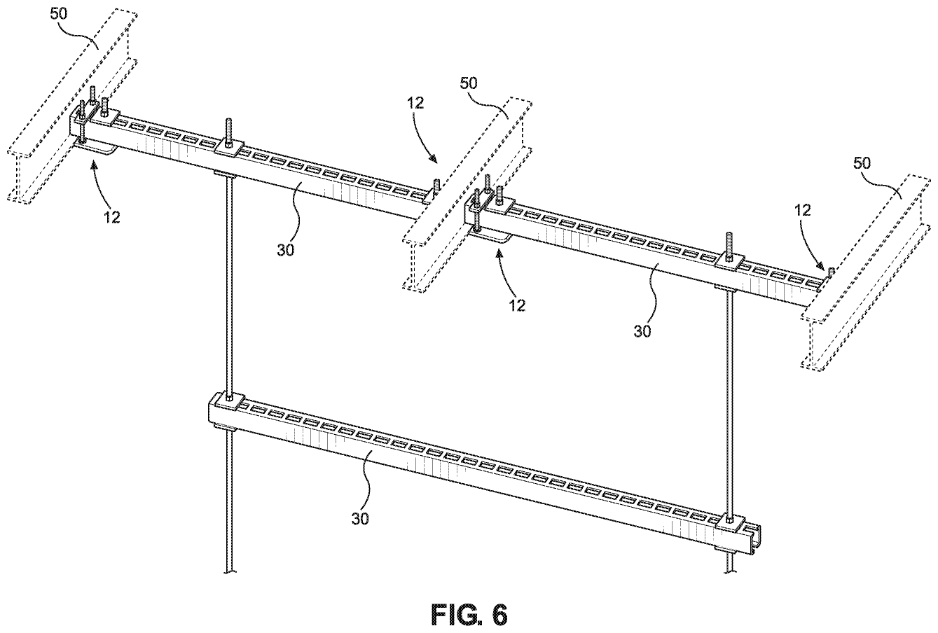

With continued reference to FIG. 1, the overhead support structure system 10 includes the clamping system 12 and a support member 30. In operation, the clamping system 12 is configured to clamp opposing ends of the support member 30 to an existing structural member of a facility. In this case, the existing structural members of the facility in which the overhead support structure system 10 is secured is the flange 52 of existing overhead I-beams 50. Clamping the support member 30 at its opposite ends between existing beams of the facility is operable to securely hang the support member 30 at a desired overhead location within the facility (see for example FIG. 5). Multiple support members 30 may also be used to form a desired overhead support pattern of support members 30 at the facility without requiring welding or lifting heavy equipment to form the support pattern (see for example FIG. 6).

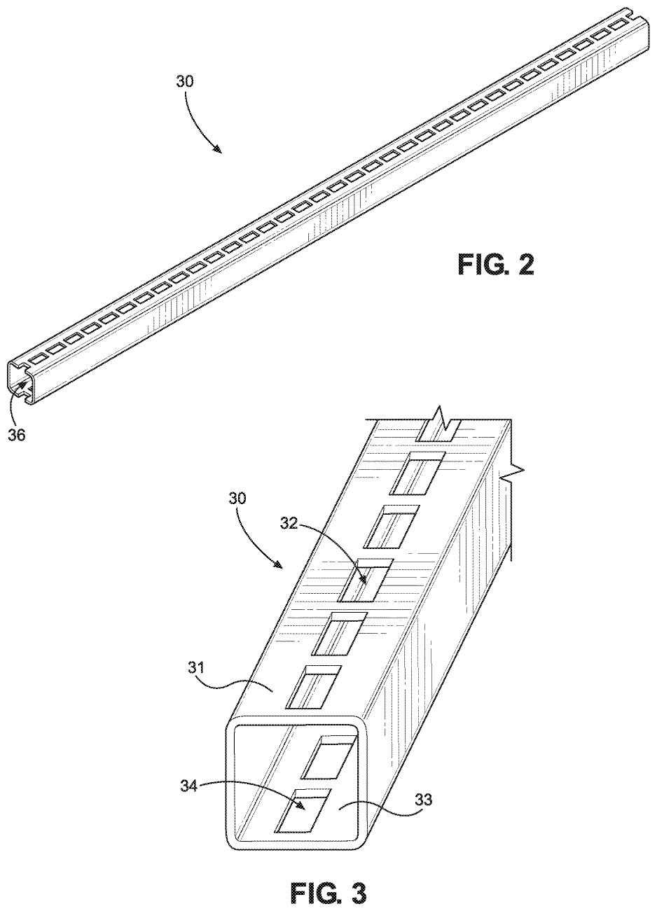

As shown best in FIGS. 2-3, an exemplary embodiment of the support member 30 of the overhead support structure system 10 is depicted in the form of an elongated tube (hereinafter “support tube 30” or “tube 30”). As shown, the support tube 30 preferably includes a hollow interior 36, a first set of slots 32 disposed in the top surface 31 of the tube 30, and a second set of slots 34 disposed in the bottom surface 31 of the tube 30. Each slot of the first set of slots 32 is preferably positioned and configured to be substantially vertically aligned with a corresponding slot of the second set of slots 34. In preferred embodiments, the hollow interior 36, first set of slots 32, and second set of slots 34 run along the length of the tube 30 so that the slots towards the middle of the tube 30 may be used to hang installation equipment when needed using bolts secured through the slots 32 and 34 (see FIG. 5). However, in installations that do not need to hang equipment from the tube 30, the hollow interior 36 and/or slots 32 and 34 may be provided only at the respective ends of the tube 30 for clamping to the existing beams 50 at the facility.

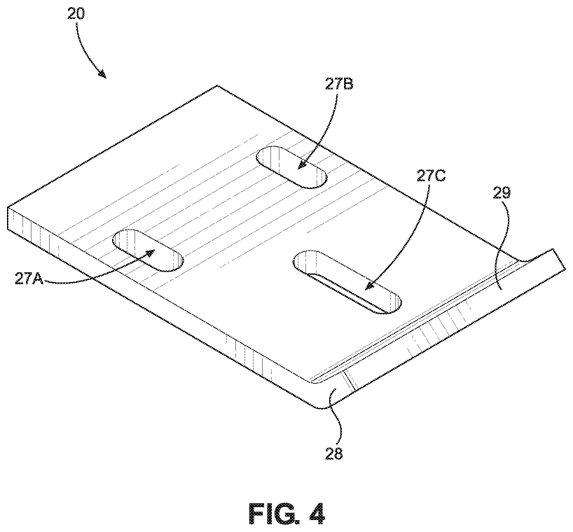

With reference back to FIG. 1, the clamping system 12 includes a top clamp member 16 and a bottom clamp member 20. The top clamp member 16 may be separated into two different plates 16A and 16B as shown, or it may be a singular plate that forms the top clamp member 16. The top clamp member 16 preferably includes a first aperture 17A and a second aperture 17B extending through the top clamp member 16 on opposite sides of a rear portion of the top clamp member 16. A third aperture 17C is then positioned adjacent a middle front portion of the top clamp member 16. As shown best in FIG. 4, the bottom clamp member 20 similarly includes a first aperture 27A and a second aperture 27B each extending through the bottom clamp member 20 adjacent a rear portion of the bottom clamp member 20. A third aperture 27C is then positioned adjacent a middle front portion of the bottom clamp member 20. When the clamping system 12 is assembled, and as shown best in FIG. 1, the first aperture 17A of the top clamp member 16 is positioned and configured to be aligned with the first aperture 27A of the bottom clamp member 20, the second aperture 17B of the top clamp member 16 is positioned and configured to be aligned with the second aperture 27B of the bottom clamp member 20, and the third aperture 17C of the top clamp member 16 is positioned and configured to be aligned with the third aperture 27C of the bottom clamp member 20.

With continued reference to FIG. 1, in operation, an end of tube 30 is positioned on top of a flange 52 of an existing I-beam 50 (or other compatible existing structural member) as depicted. The bottom clamp member 20 is positioned partially underneath the flange 52 of the I-beam 50 and partially underneath the bottom of the tube 30 such that a rear portion of the bottom clamp member 20 is disposed underneath the flange 52 and a front portion of the bottom clamp member 20 is disposed underneath the flange 52 of the I-beam 50. When properly positioned underneath the flange 52 of the I-beam 50, the first aperture 27A and second aperture 27B are positioned on opposing sides of the tube 30 adjacent to the front of the flange 52 while the third aperture 27C is aligned with one of the slots 32 of the tube 30. The top clamp member 16 is then positioned on top of the tube 30 such that the first aperture 17A of the top clamp member 16 is aligned with the first aperture 27A of the bottom clamp member 20, the second aperture 17B of the top clamp member 16 is aligned with the second aperture 27B of the bottom clamp member 20, and the third aperture 17C of the top clamp member 16 is aligned with the third aperture 27C of the bottom clamp member 20 and the corresponding slot 32 of the tube 30. Fasteners 40 such as bolts or threaded rods are then passed through each of the aligned apertures and tightened with corresponding nuts to clamp the tube 30 to the flange 52 of the I-beam 50 between the top clamp member 16 and the bottom clamp member 20. More specifically, in the embodiment shown, the first and second apertures 17A and 17B of the top clamp member 16 and corresponding first and second apertures 27A and 27B of the bottom clamp member 20 are positioned and configured such that the fasteners 40 extend through the aligned apertures on opposing sides of the tube 30 while another fastener extends through the aligned third aperture 17C of the top clamp member 16 and third aperture 27C of the bottom clamp member 20 such that the fastener also extends through corresponding aligned slots 32 of the tube 30.

With reference to FIG. 4, the apertures 27A, 27B, and 27C of the bottom clamp member 20 in this embodiment are in the form of elongated slots. On the other hand, apertures 17A, 17B, and 17C of the top clamp member 16 are preferably configured to closely receive the fasteners 40. Accordingly, an installer will insert the fasteners 40 through the apertures 17A, 17B, and 17C of the top clamp member 16 first while the slots of the bottom clamp member 20 are positioned and configured to provide tolerances in aligning with the corresponding apertures 17A, 17B, and 17C of the top clamp member 16 for assisting in receiving the fasteners during installation. In alternate embodiments, the apertures 17A, 17B, and 17C of the top clamp member 16 may be in the form of elongated slots while the corresponding apertures 27A, 27B, and 27C of the bottom clamp member 20 are dimensioned and configured to more closely receive the fasteners 40.

According to another aspect of the disclosure, bottom clamp member 20 of this embodiment includes a front portion 28 disposed in front of the third aperture 27C that is angled upwards towards the top clamp member 16 when the bottom clamp member 20 is assembled with the top clamp member 16. The front angled portion 28 of the bottom clamp member 20 is dimensioned and configured such that the top end 29 of the front portion 28 is positioned closely below the bottom surface 33 of tube 30 to provide additional support to the tube 30 following installation.

According to another aspect of the disclosure, and as noted above, the top clamp member 16 may be separated into a first plate 16A and a second plate 16B. The first plate 16A contains the first aperture 17A and second aperture 17B of the top clamp member 16 while the second plate 16B contains the third aperture 17C of the top clamp member 16. Separating the top clamp member 16 into a first plate 16A and a second plate 16B assists the installation process by allowing the installer to align the first aperture 17A and second aperture 17B of the top clamp member 16 with the first aperture 27A and second aperture 27B of the bottom clamp member 20 independently from the alignment of the third aperture 17C of the top clamp member 16 with the corresponding third aperture 27C of the bottom clamp member 20.

With reference to FIGS. 5-6, potential applications of the overhead support structure system 10 are exemplified. For example, as shown in FIG. 5, opposing ends of a support tube 30 are secured to the flanges 52 of parallel running I-beams 50 using corresponding clamping systems 12 of the present disclosure. Thus, the support tube 30 is secured/suspended between the I-beams 50. According to this application, ductwork or other types of pipes 60 are then suspended from the support tube 30 using U-shaped hangers suspended from other slots 32 of the tube 30 positioned towards the middle of the support tube 30. As should be understood, multiple support tubes 30 may be secured to the I-beams 50 in a spaced-apart fashion to support the pipes 60 along the length of the pipes 60. Additionally, the tubes 30 may also be used to support pipes 60 or other mechanical equipment by positioning the equipment on top of the support tubes 30. Relatedly, with respect to FIG. 6, various patterns of support tubes 30 may be suspended from the existing I-beams 50 of a facility as needed and depending on the desired application.

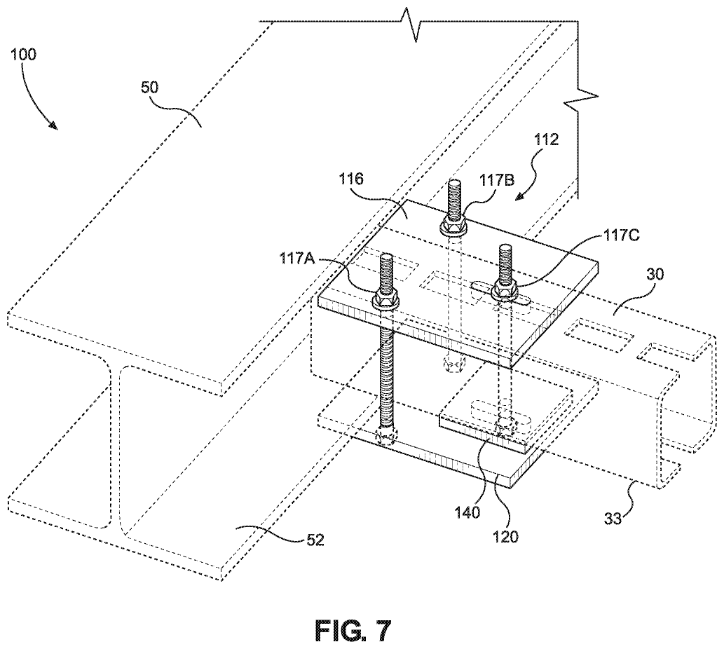

With reference to FIG. 7, an overhead support structure system 100 according to another embodiment of the disclosure is depicted. According to this embodiment, the elongated support member 30 is the same as described above with respect to the embodiment of FIGS. 1-6. Further, clamping system 112 similarly includes a top clamp member 116 and a bottom clamp member 120 designed for securing the support member 30 to the flange 52 of an I-beam 50. However, as compared to the embodiment of FIG. 1, the top clamp member 116 incorporates the first aperture 117A, second aperture 117B, and third aperture 117C within a singular plate structure. The bottom clamp member 120 similarly includes the first aperture, second aperture (hidden in FIG. 7), and third aperture (hidden in FIG. 7) into a singular plate design. As compared to the embodiment of FIGS. 1 and 4, the bottom clamp member 120 is shaped as a flat plate (i.e., the angled front portion 28 of the bottom clamp member 20 is omitted) and a washer 140 is provided to fill the space between the front portion of the bottom clamp member 120 and the bottom surface 33 of the elongated support member/tube 30. Washer 140 similarly includes an aperture for receiving the fastener as it is inserted through the aligned third aperture 117C of the top clamp member, the corresponding slots of the support tube 30, the aperture of washer 140, and the third aperture of the bottom clamp member 120.

As also shown with respect to FIG. 7, the third aperture 117C of the top clamp member 116 of this embodiment is preferably in the form of an elongated slot. A matching elongated slot is then provided as the third aperture of the bottom clamp member 120. Together, the slots allow for variations in positioning of the fastener with respect to the structural member 30 as needed during installation. Further, the top clamp member 116 and bottom clamp member 120 of this embodiment utilize the same structure, which eliminates the need for fabricating different parts for the top clamp member 116 and bottom clamp member 120.

What is claimed is:

1. An overhead support structure system comprising:
an elongated support member having a first end, the first end of the elongated support member including a hollow interior, a first aperture extending through a top surface of the elongated support member, and a second aperture extending through a bottom surface of the elongated support member, the first aperture and the second aperture of the elongated support member being positioned and configured to be vertically aligned with the hollow interior disposed between the first aperture and the second aperture;
a clamping system for clamping the first end of the elongated support member to a structural member of a facility, the clamping system including:
a top clamp member having at least a first aperture, a second aperture, and a third aperture,
a bottom clamp member having at least a first aperture, a second aperture, and a third aperture, the bottom clamp member being dimensioned and configured such that a rear portion of the bottom clamp member is operable to be positioned underneath a portion of the first structural member while a front portion of the bottom clamp member is operable to be positioned underneath the bottom surface of the first end of the elongated support member,
wherein, during installation with the top clamp member being positioned above the bottom clamp member with the first end of the elongated support member positioned between the top clamp member and the bottom clamp member, the first aperture of the top clamp member is aligned with the first aperture of the bottom clamp member adjacent a first side of the elongated support member, the second aperture of the top clamp member is aligned with the second aperture of the bottom clamp member adjacent a second side of the elongated support member, and the third aperture of the top clamp member is aligned with the third aperture of the bottom clamp member and the first and second aperture of the elongated support member, and
wherein each of the aligned apertures are dimensioned and configured to receive a fastener for securing the first end of the elongated support member to the structural member of the facility by securing the top clamp member to the bottom clamp member with the elongated support member secured between the top clamp member and the bottom clamp member.

2. The overhead support structure system of claim 1 wherein the elongated support member includes a hollow interior throughout a length of the elongated support member, a first set of spaced-apart apertures extending along the top surface of the elongated support member that includes the first aperture of the elongated support member, and a second set of spaced-apart apertures extending along the bottom surface of the elongated support member that includes the second aperture of the elongated support member, each of the apertures of the first-set of spaced-apart apertures being vertically aligned with a corresponding aperture of the second-set of spaced-apart apertures.

3. The overhead support structure system of claim 1 wherein the top clamp member includes a first plate having the first aperture and the second aperture of the top clamp member and a second plate having the third aperture of the top clamp member.

4. The overhead support structure system of claim 3 wherein the bottom clamp member is in the form of a unitary plate having the first aperture, second aperture, and third aperture of the bottom clamp member.

5. The overhead support structure system of claim 1 wherein one or more of the first aperture, second aperture, and third aperture of the bottom clamp member includes an elongated slot.

6. The overhead support structure system of claim 1 wherein the front portion of the bottom clamp member includes a raised portion having a top end that is dimensioned and configured to be positioned closely below the bottom surface of the elongated support member following installation.

7. The overhead support structure system of claim 1 wherein the structural member of the facility is an I-beam having a flange and wherein, during installation, the rear portion of the bottom clamp member is dimensioned and configured to be positioned underneath the flange of the I-beam.

8. The overhead support structure system of claim 1 wherein the clamping system further includes a washer dimensioned and configured to be positioned between the bottom surface of the elongated support member and the front portion of the bottom clamp member during installation.

9. The overhead support structure system of claim 1 wherein at least one of the third aperture of the top clamp member and the third aperture of the bottom clamp member is in the form of an elongated slot for permitting variations in the positioning of the corresponding fastener with respect to the first and second aperture of the elongated support member.

10. A method of securing an overhead support structure system to an existing structural member of a facility, the method comprising:
providing an elongated support member having a first end, the first end of the elongated support member including a hollow interior, a first aperture extending through a top surface of the elongated support member, and a second aperture extending through a bottom surface of the elongated support member, the first aperture and the second aperture of the elongated support member being positioned and configured to be vertically aligned with the hollow interior disposed between the first aperture and the second aperture;
providing a top clamp member having a first aperture, a second aperture, and a third aperture;
providing a bottom clamp member having a first aperture, a second aperture, and a third aperture;
positioning the first end of the elongated support member on top of a portion of the existing structural member of the facility;
positioning the bottom clamp member such that a rear portion of the bottom clamp member is disposed underneath the portion of the existing structural member of the facility and a front portion of the bottom clamp member is disposed underneath the bottom surface of the first end of the elongated support member;
positioning the top clamp member above the first end of the elongated support member such that the first aperture of the top clamp member is aligned with the first aperture of the bottom clamp member adjacent a first side of the elongated support member, the second aperture of the top clamp member is aligned with the second aperture of the bottom clamp member adjacent a second side of the elongated support member, and the third aperture of the top clamp member is aligned with the third aperture of the bottom clamp member and the first and second aperture of the elongated support member; and
securing the first end of the elongated support member to the existing structural member of the facility by passing fasteners through each of the aligned apertures to securing the top clamp member to the bottom clamp member with the elongated support member secured between the top clamp member and the bottom clamp member.

11. The method of claim 10 wherein the elongated support member includes a hollow interior throughout a length of the elongated support member, a first set of spaced-apart apertures extending along the top surface of the elongated support member, and a second set of spaced-apart apertures extending along the bottom surface of the elongated support member, each of the apertures of the first-set of spaced-apart apertures being vertically aligned with a corresponding aperture of the second-set of spaced-apart apertures.

12. The method of claim 10 wherein the top clamp member includes a first plate having the first aperture and the second aperture of the top clamp member and a second plate having the third aperture of the top clamp member.

13. The method of claim 12 wherein the bottom clamp member is in the form of a unitary plate having the first aperture, second aperture, and third aperture of the bottom clamp member.

14. The method of claim 10 wherein one or more of the first aperture, second aperture, and third aperture of the bottom clamp member includes an elongated slot.

15. The method of claim 10 wherein the front portion of the bottom clamp member includes a raised portion having a top end that is dimensioned and configured to be positioned closely below the bottom surface of the elongated support member during the positioning step of the bottom clamp member.

16. The method of claim 10 wherein the existing structural member of the facility is an I-beam having a flange and wherein, during the positioning step of the bottom clamp member, the rear portion of the bottom clamp member is positioned underneath the flange of the I-beam.

17. The method of claim 10 further comprising positioning a washer between the bottom surface of the elongated support member and the front portion of the bottom clamp member.

18. The method of claim 10 wherein at least one of the third aperture of the top clamp member and the third aperture of the bottom clamp member is in the form of an elongated slot for permitting variations in the positioning of the corresponding fastener with respect to the first and second aperture of the elongated support member.
